(19) United States
(12) Patent Application Publication
(10) Pub. No.: US 2026/0268652 A1
(43) Pub. Date: Sep. 10, 2026

(54) METHOD AND SYSTEM FOR REAL TIME CLOUD IMAGE RECOGNITION USING CAMERA FEED

(71) Applicant: Flying Flamingos India Private Limited, Bangalore (IN)

(72) Inventors: Amit Gaiki, Bangalore (IN); Shourya Agarwal, Ajmer (IN); Debaditya Sen, West Bengal (IN)

(73) Assignee: Flying Flamingos India Private Limited, Bangalore (IN)

(21) Appl. No.: 19/463,497

(22) Filed: Jan. 29, 2026

(30) Foreign Application Priority Data
Jan. 29, 2025 (IN) 202541007308

(51) Int. Cl. G06V 10/94; G06V 10/42; G06V 10/44; G06V 10/74; G06V 10/82; G06V 20/20

(52) U.S. Cl. CPC G06V 10/95; G06V 10/42; G06V 10/44; G06V 10/761; G06V 10/82; G06V 10/955; G06V 20/20

(57) ABSTRACT

A system, method and a non-transitory computer readable storage medium for performing distributed image recognition on a hybrid recognition pipeline are disclosed. The system receives an image of a physical environment, extracts global features and local features from the image and transmits the global features to a cloud server storing a plurality of pre-computed feature descriptors. The cloud server executes a global similarity search to identify candidate reference images, transmits local descriptor matching and generates refined similarity scores. The system fuses the refined and the global similarity scores to determine a final recognition result, fuses the similarity scores, and execute refinement of the initial recognition result. Further, the system generates one or more final recognition outputs corresponding to at least one identified physical object based on the re-ranked results received from the cloud server and displays the one or more final recognition outputs in real time.

### TECHNICAL FIELD

The present invention relates to the field of augmented reality systems and methods. Specifically, the present invention relates to systems and methods for image recognition in augmented reality systems.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Augmented reality (AR) applications are increasingly being integrated into various industries, such as gaming, education, and retail, to provide immersive and interactive experiences. However, a key challenge in the widespread adoption of AR technology is the slow and unreliable performance of image recognition systems, which are critical for providing real-time interactions. The need for fast and accurate recognition of objects and environments is essential for maintaining the fluidity and responsiveness of AR applications. Unfortunately, existing image recognition solutions are often computationally expensive, requiring significant processing power and time. This leads to a negative impact on the overall performance and user experience. Additionally, these systems may struggle with diverse lighting conditions, complex backgrounds, or occlusions, which further degrade the accuracy and reliability of object detection.

The complexity of current AR image recognition systems can lead to delays in rendering and interaction, creating frustration for users and limiting the scalability of AR technologies. Furthermore, the reliance on high-end hardware for processing often makes these solutions inaccessible for consumers using mobile devices or lower-powered devices. To address these shortcomings, researchers and developers have been exploring alternative methods for optimizing image recognition algorithms. However, many of these approaches still fail to provide the necessary balance of accuracy, speed, and efficiency.

In the light of the above, there is a need for a method and system that overcomes the above problem statements.

### SUMMARY

In an aspect, a system for performing distributed image recognition on a hybrid recognition pipeline is disclosed. The system includes one or more processors and a non-transitory memory storing instructions. The instructions, when executed by the one or more processors, cause the system to receive, using a receiving module at a communication device, at least one image of a physical environment captured by one or more sensors integrated in the communication device. The system includes a feature extraction module at the communication device configured to extract one or more global features and one or more local features from the received image. The system includes an uplink module at the communication device configured to transmit the one or more global features to a cloud server configured with a reference vector database storing a plurality of pre-computed feature descriptors. The system includes an execution module at the cloud server configured to execute a global similarity search operation. The search operation includes comparing the one or more global features with a plurality of pre-computed feature descriptors stored in the reference vector database. In addition, the execution module calculates one or more global similarity scores. The one or more global similarity scores represent a degree of similarity between the one or more global features and the plurality of pre-computed feature descriptors. Further, the execution module identifies one or more candidate reference images based on the calculated similarity scores. The one or more candidate reference images are ranked according to a corresponding degree of similarity with the one or more global features. The system includes a relay module at the cloud server configured to transmit one or more sets of pre-computed descriptors corresponding to the one or more candidate reference images to the communication device. The system includes a descriptor matching module at the communication device configured to perform local descriptor matching between the one or more candidate reference images and the one or more local features to generate one or more refined similarity scores. The system includes a fusion module configured to fuse the one or more refined similarity scores with the one or more global similarity scores to determine an initial recognition result. The system includes an iterative ranking module distributed between the communication device and the cloud server. The ranking module is configured to perform continuous refinement of recognition results based on newly extracted local features transmitted from the communication device to the cloud server. The one or more processors generate one or more final recognition outputs corresponding to at least one identified physical object based on the re-ranked results. The re-ranked results are received from the cloud server. The communication device displays one or more of the recognition outputs in real time.

In an embodiment of the present disclosure, the feature extraction module employs a hybrid neural processing framework combining a convolutional backbone for generating the one or more global features and a binary descriptor encoder for lightweight on-device feature extraction to reduce computational load and transmission bandwidth.

In an embodiment of the present disclosure, the descriptor matching module executes local matching using a hierarchical descriptor tree structure. The descriptor matching module performs Hamming distance computation between the one or more local features and the one or more candidate reference image descriptors to generate refined similarity scores.

In an embodiment of the present disclosure, the fusion module applies a weighted normalization function for fusing the one or more global similarity scores and the one or more refined similarity scores. The weights are dynamically computed based on a confidence value derived from a number of the candidate reference images and a consistency of matched descriptor regions.

In an embodiment of the present disclosure, the system enables execution of the global similarity search at the cloud server. The system enables the execution of the one or more local descriptor matching and the re-ranking operations at the communication device.

In an embodiment of the present disclosure, the ranking module performs progressive refinement of recognition results. The progressive refinement is done by continuously receiving newly extracted local features from the communication device and reordering the candidate reference images at the cloud server in real time.

In an embodiment of the present disclosure, the system dynamically adjusts distribution of computational load between the communication device and the cloud server. The distribution of the computational load is adjusted based on processing capability, network conditions, or energy constraints of the communication device.

In an embodiment of the present disclosure, the cloud server employs a reference vector database. The reference vector database includes a plurality of pre-computed feature descriptors. In addition, the cloud server utilizes the plurality of pre-computed feature descriptors from the reference vector to execute the global similarity search. The cloud server employs a near-neighbour indexing technique for executing the global similarity search. The near-neighbour indexing technique includes one of a locality-sensitive hashing, product quantization, or hierarchical navigable small-world graphs.

In an embodiment of the present disclosure, the communication device transmits additional sensor data including at least one of a depth map, an accelerometer reading, or a gyroscope signal to the cloud server, and the cloud server fuses the additional sensor data with the visual features for improving recognition accuracy under variable lighting or occlusion conditions.

In an embodiment of the present disclosure, the system supports a server-exclusive processing mode in which the communication device transmits the at least one image directly to the cloud server, and the cloud server performs the feature extraction, similarity search, and re-ranking to generate the final recognition outputs without local processing on the communication device.

In an embodiment of the present disclosure, the system performs context-aware optimization by compressing transmitted feature embeddings using a quantized encoding scheme and applying a latency feedback mechanism from the communication device to the cloud server for adaptive frame-rate control.

In an embodiment of the present disclosure, the system employs multimodal data fusion by combining the visual features with the sensor data to improve recognition accuracy in complex real-world environments including low light, occlusion, or motion.

In an embodiment of the present disclosure, the system enables collaborative or shared image recognition sessions by synchronizing recognition outputs and re-ranking results across multiple communication devices connected to the same cloud server instance.

In another aspect, a method for performing distributed image recognition on a hybrid recognition pipeline is disclosed. The method includes a step of receiving, at a communication device, at least one image of a physical environment captured by one or more sensors integrated in the communication device. The method includes another step of extracting, at the communication device, one or more global features and one or more local features from the received image. The method includes yet another step of transmitting, from the communication device to a cloud server, the one or more global features to perform a global similarity search operation. The global similarity search operation includes a step of comparing the one or more global features with a plurality of pre-computed feature descriptors. The plurality of pre-computed feature descriptors are stored in the reference vector database. In addition, the search operation includes a subsequent step of calculating one or more global similarity scores. The one or more global similarity scores represent a degree of similarity between the one or more global features and the plurality of pre-computed feature descriptors. Further, the global similarity search operation includes another step of identifying one or more candidate reference images based on the calculated similarity scores. The one or more candidate reference images are ranked according to a corresponding degree of similarity with the one or more global features. The method includes yet another step of transmitting one or more sets of pre-computed descriptors corresponding to the one or more candidate reference images to the communication device. The method includes yet another step of performing local descriptor matching between the one or more local features and the one or more candidate reference image descriptors to generate refined similarity scores. The method includes yet another step of fusing the one or more refined similarity scores with the one or more global similarity scores to determine an initial recognition result. The method includes yet another step of executing an iterative re-ranking process distributed between the communication device and the cloud server to continuously refine the recognition results based on additional local features extracted from subsequent camera frames. The method includes yet another step of generating final recognition outputs corresponding to one or more identified physical objects based on the re-ranked results. Further, the method includes yet another step of displaying the final recognition outputs in real time at the communication device. The method includes yet another step of performing, at the cloud server, a complete recognition pipeline including feature extraction, similarity search, and re-ranking when operating in a server-exclusive mode.

In an embodiment of the present disclosure, the hybrid neural processing framework combines a convolutional backbone for generating the one or more global features and the one or more local features for lightweight on-device feature extraction.

In an embodiment of the present disclosure, the local matching is executed using a hierarchical descriptor tree structure and Hamming distance computation between the one or more local features and the one or more candidate reference image descriptors to generate the one or more refined similarity scores.

In an embodiment of the present disclosure, a weighted normalization function is used for fusing the one or more global similarity scores and the one or more refined similarity scores, wherein the fusion dynamically computes weights based on a confidence value derived from a number of the candidate reference images and a consistency of matched descriptor regions.

In an embodiment of the present disclosure, the method includes operation in an edge–cloud cooperative mode. The edge-cloud cooperative mode includes executing the global similarity search at the cloud server, and executing the local descriptor matching, the fusion, and the re-ranking operations at the communication device to balance latency, bandwidth, and computational efficiency.

In an embodiment of the present disclosure, the progressive refinement of the recognition results continuously receives newly extracted local features from the communication device and reordering candidate reference images at the cloud server in real time.

In an embodiment of the present disclosure, the method includes dynamically adjusting distribution of computational load between the communication device and the cloud server based on processing capability, network conditions, or energy constraints of the communication device.

In an embodiment of the present disclosure, the method further includes employing a reference vector database for storing a plurality of pre-computed feature descriptors, and executes the global similarity search using a near-neighbour indexing technique, wherein the near-neighbour indexing technique comprises one of locality-sensitive hashing, product quantization, or hierarchical navigable small-world graphs.

In an embodiment of the present disclosure, the method includes transmitting sensor data for enhanced recognition accuracy, wherein the sensor data comprises at least one of a depth map, an accelerometer reading, or a gyroscope signal, and wherein the cloud server fuses the sensor data with the visual features for improving recognition accuracy under variable lighting or occlusion conditions.

In yet another aspect, a non-transitory computer-readable medium storing instructions that, when executed by one or more processors, cause the system to perform the method for performing distributed image recognition on a hybrid recognition pipeline. The method includes a step of receiving, at a communication device, at least one image of a physical environment captured by one or more sensors integrated in the communication device. The method includes another step of extracting, at the communication device, one or more global features and one or more local features from the received image. The method includes yet another step of transmitting, from the communication device to a cloud server, the one or more global features to perform a global similarity search operation. The global similarity search operation includes a step of comparing the one or more global features with a plurality of pre-computed feature descriptors. The plurality of pre-computed feature descriptors stored in the reference vector database. In addition, the search operation includes a subsequent step of calculating one or more global similarity scores. The one or more global similarity scores represent a degree of similarity between the one or more global features and the plurality of pre-computed feature descriptors. Further, the global similarity search operation includes another step of identifying one or more candidate reference images based on the calculated similarity scores. The one or more candidate reference images are ranked according to a corresponding degree of similarity with the one or more global features. The method includes yet another step of transmitting one or more sets of pre-computed descriptors corresponding to the one or more candidate reference images to the communication device. The method includes yet another step of performing local descriptor matching between the one or more local features and the one or more candidate reference image descriptors to generate refined similarity scores. The method includes yet another step of fusing the one or more refined similarity scores with the one or more global similarity scores to determine an initial recognition result. The method includes yet another step of executing an iterative re-ranking process distributed between the communication device and the cloud server to continuously refine the recognition results based on additional local features extracted from subsequent camera frames. The method includes yet another step of generating final recognition outputs corresponding to one or more identified physical objects based on the re-ranked results. Further, the method includes yet another step of displaying the final recognition outputs in real time at the communication device. The method includes yet another step of performing, at the cloud server, a complete recognition pipeline including feature extraction, similarity search, and re-ranking when operating in a server-exclusive mode.

### BRIEF DESCRIPTION OF DRAWINGS

Having thus described the disclosure in general terms, references will now be made to the accompanying figures, wherein:

FIG. 1 illustrates an exemplary computing environment for performing distributed image recognition and contextual mixed reality (MR) rendering based on a hybrid recognition pipeline, in accordance with various embodiments of the present disclosure;

FIG. 2 illustrates an exemplary functional block diagram of a system showing internal components for executing the distributed image recognition and the contextual mixed reality (MR) rendering based on the hybrid recognition pipeline, in accordance with various embodiments of the present disclosure;

FIG. 3 illustrates a flowchart of a method for performing the distributed image recognition and the contextual mixed reality (MR) rendering based on the hybrid recognition pipeline, in accordance with various embodiments of the present disclosure; and

FIG. 4 illustrates a block diagram of an exemplary device, in accordance with various embodiment of the present disclosure.

It should be noted that the accompanying figures are intended to present illustrations of exemplary embodiments of the present disclosure. The figures are not intended to limit the scope of the present disclosure. It should also be noted that accompanying figures are not necessarily drawn to scale.

### DETAILED DESCRIPTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word "may" is used in a permissive sense (i.e. meaning having the potential to), rather than the mandatory sense, (i.e. meaning must). Further, the words "a" or "an" mean "at least one” and the word “plurality” means “one or more” unless otherwise mentioned. Furthermore, the terminology and phraseology used herein is solely used for descriptive purposes and should not be construed as limiting in scope. Language such as "including," "comprising," "having," "containing," or "involving," and variations thereof, is intended to be broad and encompass the subject matter listed thereafter, equivalents, and additional subject matter not recited, and is not intended to exclude other additives, components, integers, or steps. Likewise, the term "comprising" is considered synonymous with the terms "including" or "containing" for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. The values and ranges are to be treated as examples only, and are not intended to limit the scope of the claims. In addition, a number of system architectures are identified as suitable for various facets of the implementations. The system architectures are to be treated as exemplary and are not intended to limit the scope of the invention.

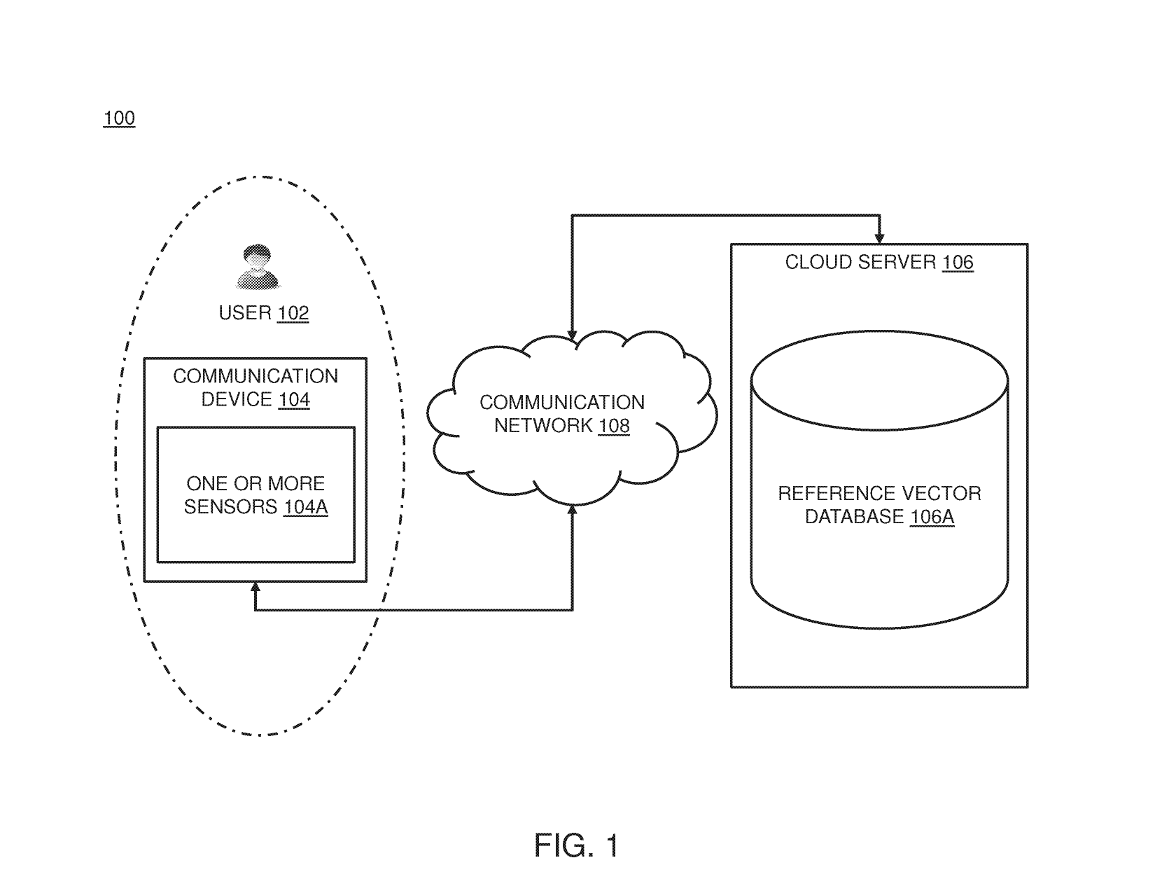

FIG. 1 illustrates a distributed computing environment 100 for performing hybrid and distributed image recognition and visualization of recognition results, in accordance with various embodiments of the present disclosure. The distributed computing environment 100 enables execution of an image recognition system (hereinafter referred to as “the system”) that performs the distributed image recognition. The system performs the distributed image recognition through cooperative processing between the communication device 104 and the cloud server 106. The system performs a cloud-assisted image recognition process using real-time image feed captured by one or more sensors 104A associated with the communication device 104.

The image recognition experience refers to a digitally assisted environment that interprets physical surroundings and identifies real-world objects in real time. The recognition experience allows the user 102 to capture scenes, initiate distributed processing, and view the identified objects and contextual information through the communication device 104. The recognition outputs include object labels, scene classifications, or similarity indications that dynamically update as the environment changes.

The distributed computing environment 100 enables the cooperative processing to recognize physical environments and display corresponding recognition outputs in real time. The distributed computing environment 100 includes the communication device 104 associated with a user 102, the cloud server 106 associated with a reference vector database 106a, and a communication network 108. The above-mentioned components are operatively coupled and function together to achieve distributed recognition, adaptive similarity search, and context-aware visualization of recognition outputs.

The user 102 represents an individual initiating the recognition process through the communication device 104. The user 102 points the communication device 104 toward an object, surface, or scene, upon which the communication device 104 captures one or more images of the environment and begins the distributed recognition sequence. The communication device 104 refers to a user-operated computing platform configured to capture the one or more images of the physical environment. In addition, the communication device 104 performs preliminary feature processing, and displays recognition outputs based on results received from the cloud server 106. The communication device 104 functions as the client-side component of the hybrid recognition architecture and executes a lightweight runtime optimized for on-device feature extraction and real-time visualization. Examples of the communication device 104 include smartphones, tablets, AR-enabled wearable devices, head-mounted displays, or any portable electronic device equipped with an imaging unit and network communication interface. The communication device 104 locally processes captured image frames to extract one or more global features and one or more local features and collaborates with the cloud server 106 to execute the distributed image recognition process.

The communication device 104 includes one or more sensors 104A configured to capture environmental and positional data of the surrounding scene. In an embodiment of the present disclosure, the one or more sensors 104A include an RGB camera, a depth sensor, a LiDAR unit, and an inertial measurement unit (IMU). The RGB camera captures color images of the physical environment, the depth sensor or LiDAR provides three-dimensional spatial information such as distance or depth maps, and the IMU provides motion and orientation data. The one or more sensors 104A collectively enable the system 100 to acquire both visual and spatial context required for accurate image recognition and alignment of virtual augmentations in augmented reality applications. The one or more sensors 104A operate in synchronization under the control of the communication device 104 to generate a unified data stream representing the real-world environment from multiple perspectives.

In an embodiment, the system executed within the distributed computing environment 100 performs efficient and lightweight augmented reality (AR) image recognition. The system combines existing AR frameworks with a custom cloud-based image recognition process. The system leverages both client-side and server-side processing to achieve near real-time image matching. In addition, the system improves overall recognition performance and user experience. The cooperative processing architecture enables dynamic collaboration between the communication device 104 and the cloud server 106. In addition, the architecture ensures that computationally intensive tasks are performed in the cloud server 106 and time-sensitive operations are handled locally on the communication device 104.

On the client side, the communication device 104 captures image data through the one or more sensors 104A and executes efficient algorithms to extract key local and global features from the captured frames. The global features represent compact semantic embeddings that summarize the captured scene. The local features represent fine-grained geometric patterns. The communication device 104 transmits the most discriminative global features to the cloud server 106 to reduce uplink bandwidth requirements.

The cloud server 106 is a backend processing entity configured to perform high-precision similarity search and contextual recognition. The cloud server 106 maintains the reference vector database 106a. The reference vector database 106a refers to a non-transitory data storage system containing indexed embeddings representing known objects or scenes. Each entry within the reference vector database 106a is associated with metadata such as object type, environmental context, illumination attributes, and temporal timestamp. The reference vector database 106a supports high-speed retrieval using Approximate Nearest Neighbor (ANN) search algorithms or hash-based indexing to ensure low-latency matching across large-scale datasets.

The reference vector database 106a stores a large number of reference images with pre-computed feature descriptors. Upon receiving the global features, the cloud server 106 conducts a similarity search within the reference vector database 106a. The cloud server 106 utilizes near-neighbour indexing techniques to conduct the similarity search. Accordingly, the cloud server 106 identifies one or more candidate reference images based on the similarity search results. The one or more candidate reference images exhibit highest similarity scores.

In an embodiment, the cloud server 106 identifies top-k candidate reference images that exhibit the highest similarity scores relative to the transmitted embeddings. The cloud server 106 transmits the corresponding descriptors and metadata of the identified candidate images to the communication device 104 through the communication network 108. The communication network 108 facilitates bidirectional data exchange between the communication device 104 and the cloud server 106. The communication network 108 operates over wired or wireless communication protocols including 5G, Wi-Fi, LTE, or satellite links, ensuring secure and synchronized communication for distributed recognition sessions.

On the client side, the communication device 104 uses the received descriptors to perform re-ranking and local refinement of the recognition results. The communication device 104 performs matching of the received reference descriptors with the one or more local features extracted from the captured image. Accordingly, the communication device 104 generates, based on the matching, refined similarity scores that improve both precision and contextual alignment. The iterative process allows the system to continuously refine recognition accuracy as new frames are captured or as the user 102 changes viewing angles within the augmented environment.

The distributed configuration allows computational tasks to be divided between the communication device 104 and the cloud server 106 to balance latency, bandwidth utilization, and recognition accuracy. The communication device 104 performs real-time acquisition of image data and feature extraction locally. The cloud server 106 executes large-scale similarity searches and ranking operations using the reference vector database 106a. The cooperative distribution ensures that the image recognition process remains responsive on resource-constrained devices and maintains precision and scalability of the cloud-based processing.

The hybrid recognition process allows the system to maintain near real-time responsiveness, even on resource-constrained mobile devices. The communication device 104 preserves battery life and reduces local processing load by offloading computationally heavy similarity searches to the cloud server 106. The architecture supports scalable deployment across multiple users, with each cloud instance handling a dedicated recognition session or dataset subset. In addition, the architecture enables parallel and distributed operation across numerous devices.

The combination of the client-side and the server-side processing optimizes speed and accuracy. Also, the combination ensures that recognized objects are identified promptly and visual overlays are aligned contextually. The distributed architecture allows the system 100 to scale dynamically, accommodating larger datasets and a growing number of concurrent users without compromising latency. The system ensures a responsive and accurate augmented reality experience suitable for applications requiring complex image recognition and continuous real-time interaction.

In an embodiment of the present disclosure, the system is compatible with existing augmented reality frameworks. The system allows easy integration into mobile AR applications. The client-side processing components are designed to run efficiently within standard AR frameworks, providing accurate environment recognition without additional hardware requirements. The integration enables developers to embed the recognition capabilities of the system 100 into consumer-grade AR platforms for a wide range of use cases. The use cases may include object recognition, cultural heritage visualization, retail product identification, and industrial maintenance guidance.

The distributed computing environment 100 described in FIG. 1 thus enables cooperative client–server image recognition across cloud and device components. By combining global feature search, local descriptor matching, and continuous re-ranking within a unified workflow, the system 100 achieves accurate and efficient identification of objects within real-world environments while maintaining real-time responsiveness on the communication device 104.

The cloud server 106 maintains session state information to ensure continuity of recognition and rendering operations. The session state includes identifiers of user sessions, image contexts, and retrieved asset metadata. This information enables the distributed system to resume incomplete sessions without re-processing the entire recognition pipeline. In an embodiment of the present disclosure, the cloud server 106 uses a latency feedback mechanism to adapt frame rates and data transmission sizes based on real-time network conditions. This adaptive control ensures that the distributed recognition pipeline maintains consistency even under variable network bandwidth. The reference vector database 106a may include a hybrid data architecture combining relational storage for metadata and vector-based storage for feature embeddings. The architecture enables high-speed retrieval and scalable storage of millions of embedding vectors while supporting continuous updates as new objects are added to the distributed system.

The distributed computing environment 100 described in FIG. 1 thus enables hybrid recognition across cloud and client components. By combining global embedding search and local descriptor matching within a synchronized workflow, the distributed system achieves both accuracy and efficiency in recognizing objects within real-world environments. While FIG. 1 illustrates a single user 102 interacting with a single communication device 104, multiple users may simultaneously interact with the corresponding communication devices 104 in parallel. Each of the communication device 104 independently executes the image recognition operations.

The number and arrangement of systems, devices, and networks shown in FIG. 1 are provided merely as illustrative examples and may vary depending on implementation scenarios. In some embodiments, additional cloud nodes, edge-computing gateways, or distributed repositories may be introduced for improved scalability and reduced latency. In another embodiment, certain functions performed by the cloud server 106, such as vector similarity search or asset retrieval, may be offloaded to an edge node or executed locally on the communication device 104 when operating in a low-connectivity mode. Conversely, multiple cloud servers may collectively operate in a federated environment to handle large-scale recognition workloads. The architectural flexibility enables the interactive environment 100 to adapt to diverse deployment topologies spanning smartphones, tablets, AR headsets, or embedded vision systems.

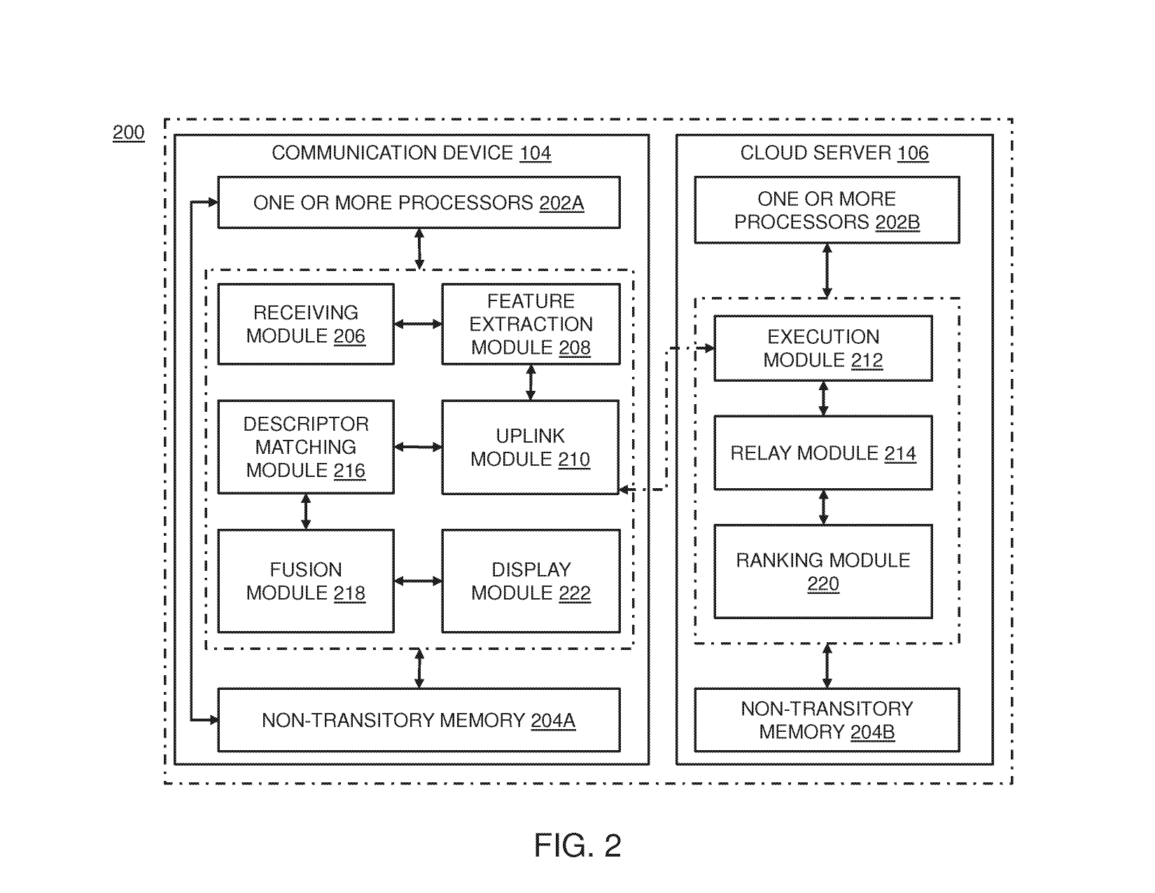

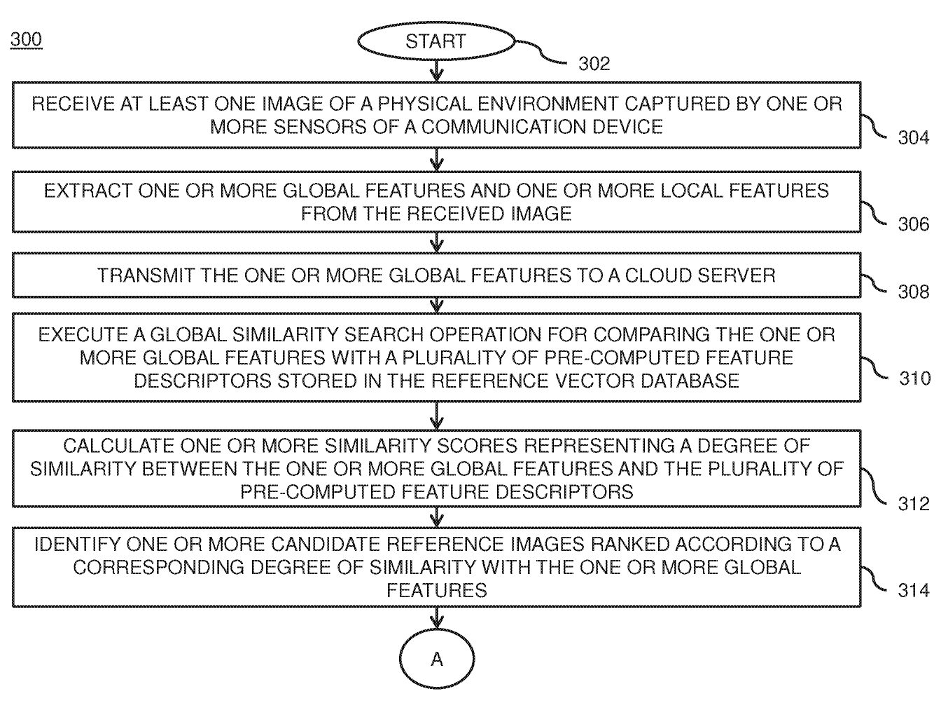

FIG. 2 illustrates a block diagram 200 showing a plurality of functional components of the communication device 104 and the cloud server 106, in accordance with various embodiments of the present disclosure. The plurality of functional components are configured to collectively perform the distributed image recognition based on the hybrid recognition pipeline. The hybrid recognition pipeline combines on-device and cloud-based processing. The plurality of functional components are distributed between the communication device 104 and the cloud server 106. In addition, the plurality of functional components collectively enable near real-time image recognition through collaborative extraction, transmission, comparison, and fusion of feature descriptors.

Further, the communication device 104 and the cloud server 106 operate as a cooperative distributed system that dynamically divides processing tasks to optimize latency, bandwidth usage, and recognition accuracy. Each of the plurality of functional components performs a distinct process contributing to the overall workflow. The workflow begins with the acquisition of the one or more images of the physical environment and the extraction of one or more global features and one or more local features. The extracted one or more global features are transmitted to the cloud server 106 for a global similarity search. The global similarity search is performed at the cloud server 106 using information stored on the reference vector database 106a. The global similarity search is done to identify one or more candidate reference images. The one or more candidate reference images exhibit the highest similarity scores. The corresponding pre-computed descriptors of the one or more candidate reference images are relayed to the communication device 104. Upon receiving the candidate reference images, the communication device 104 receives performs local descriptor matching, and generation of refined similarity scores. In addition, the communication device 104 performs fusion of the one or more global similarity scores and the one or more refined similarity scores, and progressive re-ranking of recognition results based on subsequent local feature updates. The workflow concludes with the display of final recognition outputs on the communication device 104 in real time.

The architecture distributes computational work across a client side and a cloud side to balance device performance and network efficiency. The client side includes one or more processors 202a and a non-transitory memory 204a located on the communication device 104. The cloud side includes one or more processors 202b and a non-transitory memory 204b located on the cloud server 106. The modular hybrid recognition pipeline includes a coordinated set of modules. The set of modules are configured for image reception, feature extraction, uplink transmission, similarity search, candidate relay, local descriptor matching, fusion, and iterative re-ranking. The distributed design enables high-accuracy recognition on both high-performance and resource-constrained communication devices.

The set of modules include a receiving module 206, a feature extraction module 208, an uplink module 210, an execution module 212, a relay module 214, and a descriptor matching module 216. In addition, the set of modules include a fusion module 218, a ranking module 220, and a display module 222. The plurality of modules collectively form the hybrid recognition pipeline distributed between the communication device 104 and the cloud server 106.

The set of modules include a first set of modules and a second set of modules. The client side executes the first set of modules and the cloud side executes the second set of modules. The first set of modules perform image acquisition, feature extraction, descriptor transmission, local descriptor matching, fusion of similarity measures, continuous re-ranking, and display of recognition results. The second set of modules perform global similarity search, candidate selection, re-ranking updates, and relay of recognition data. Each module exposes a standardized input/output interface and communicates securely over the communication network 108 to maintain data integrity and synchronization across distributed processing instances.

The system supports an edge–cloud cooperative mode in which the global similarity search executes at the cloud server 106. The descriptor matching, fusion, and re-ranking execute on the communication device 104. The cooperative mode minimizes latency and bandwidth consumption. In another configuration, the system operates in a server-exclusive processing mode in which the communication device 104 transmits the at least one captured image directly to the cloud server 106. Accordingly, the cloud server 106 performs the feature extraction, similarity search, and re-ranking to generate final recognition outputs without requiring local computation on the communication device 104.

Each module exposes a standardized input/output interface and uses secure transport for inter-component communication. The design uses session identifiers and per-frame timestamps to maintain temporal coherence across distributed processing. The system includes program instructions stored in the non-transitory memory 204a and the non-transitory memory 204b. The one or more processors 202a and 202b execute the program instructions. The program instructions direct the communication device 104 to capture and pre-process image data from the one or more sensors 104A, extract one or more global features and one or more local features, and transmit the global features to the cloud server 106. The program instructions further direct the cloud server 106 to perform a global similarity search, generate a candidate reference image set, and relay one or more pre-computed descriptors of the candidate reference images to the communication device 104 for subsequent local matching and fusion.

The communication device 104 and the cloud server 106 cooperatively execute the hybrid recognition pipeline in a distributed manner to balance processing load and maintain low latency. The hybrid pipeline enables real-time responsiveness even under variable network conditions by dynamically adjusting the computational split between the client and the server. The system adapts the load distribution based on processor availability, network conditions, or energy constraints of the communication device 104. When network latency is low, feature extraction and matching execute locally on the communication device 104. When network latency increases or device resources are constrained, additional computations shift to the cloud server 106 for execution.

The architecture supports both edge–cloud cooperative and server-exclusive processing modes. In the edge–cloud cooperative mode, the execution module 212 at the cloud server 106 performs the global similarity search and transmits candidate descriptors to the communication device 104. The descriptor matching module 216, the fusion module 218, and the ranking module 220 execute locally to perform correlation, fusion, and progressive refinement of recognition scores. In the server-exclusive mode, the communication device 104 transmits the raw image directly to the cloud server 106, and the cloud server 106 executes the feature extraction, global similarity search, and re-ranking functions to generate the final recognition results. The final recognition results are displayed at the communication device 104 using the display module 222.

The system supports real-time scalability by maintaining synchronized sessions between the communication device 104 and the cloud server 106. The communication device 104 associates each captured frame with contextual metadata, including timestamp, sensor identifiers, device orientation, and environmental lighting parameters. This metadata enables temporal alignment between the local descriptor matching results and the one or more global similarity scores computed on the cloud server 106. The system maintains continuous bidirectional data exchange between the fusion module 218 and the execution module 212 through the ranking module 220 to enable progressive re-ranking and refinement of the recognition outputs.

The system handles single-frame and multi-frame recognition modes. For single-frame use cases, the system performs the recognition process on a static image and produces a final recognition output after a single exchange cycle. For continuous scanning scenarios, the communication device 104 continuously extracts additional local features from sequential frames and transmits the newly extracted local features to the cloud server 106 for re-ranking. The ranking module 220 updates the candidate ordering on the cloud server 106 based on the one or more refined similarity scores computed by the descriptor matching module 216 and transmits the updated rankings to the communication device 104 for display in real time.

In an embodiment of the present disclosure, the system fuses multimodal sensor data to enhance recognition accuracy. The communication device 104 transmits auxiliary sensor data, along with the global and local features to the cloud server 106. The sensor data may include depth maps, accelerometer readings, or gyroscope signals to the cloud server 106. The execution module 212 fuses the auxiliary sensor data with the local features and the global features to refine recognition under complex conditions such as occlusions, reflections, or variable illumination. The multimodal integration enhances robustness and stability of the recognition pipeline.

The system employs a dynamic feedback mechanism using the ranking module 220 to maintain recognition accuracy and efficiency. When the ranking module 220 detects that recognition confidence has fallen below a defined threshold, the communication device 104 re-initiates the feature extraction process. The communication device 104 captures additional local features and transmits them to the cloud server 106 for iterative refinement. The cloud server 106 performs an updated similarity computation and reorders the candidate reference images accordingly. The iterative process continues until the ranking module 220 determines that the recognition results have stabilized or the system reaches a timeout condition. The final recognition outputs are displayed on the communication device 104 through the display module 222.

In an embodiment of the present disclosure, the system dynamically adjusts distribution of computational tasks between the communication device 104 and the cloud server 106. The dynamic adjustment is done based on the processing capacity, battery level, and network conditions of the communication device 104. For high-performance devices, a greater portion of feature extraction and matching may be executed locally. The resource-constrained devices may offload additional processing to the cloud. The adaptive task allocation ensures consistent recognition latency and performance across a wide range of hardware platforms.

The one or more processors 202a, using the receiving module 206, receive at least one image of a physical environment. The at least one image is captured by the one or more sensors 104A embedded in the communication device 104. The receiving module 206 operates as an entry point to the hybrid recognition pipeline and manages the image acquisition, validation, and pre-processing. The receiving module 206 controls the one or more sensors 104A to capture frames of the environment surrounding the user 102. The receiving module 206 prepares the captured frames for feature extraction and subsequent distributed recognition.

The one or more sensors 104A include at least one camera, a depth sensor, an infrared sensor, or an inertial measurement unit (IMU). Each sensor provides distinct information representing the real-world scene. The receiving module 206 fuses the multimodal sensor data into a synchronized frame sequence. The receiving module 206 performs synchronized fusion of the captured frames by aligning timestamps, adjusting exposure parameters, and normalizing image dimensions. The synchronization ensures temporal consistency between the captured frames and prevents frame-to-frame misalignment during distributed recognition.

The receiving module 206 may perform frame selection and quality evaluation before forwarding the at least one image for the feature extraction. Inn an example implementation, the quality evaluation includes focus assessment, motion blur detection, and exposure correction. The receiving module 206 may compute a sharpness score using a Laplacian-variance method and rejects frames below a defined threshold. Also, the receiving module 206 detects over-exposed or under-exposed frames using histogram-based luminance analysis and automatically adjusts camera parameters to maintain suitable brightness.

The pre-processing includes color normalization, noise reduction, and geometric undistortion using calibration parameters stored in the non-transitory memory 204a. In an embodiment of the present disclosure, the receiving module 206 operates in a burst-capture mode to enhance recognition under motion or low-light conditions. The burst-capture mode collects multiple consecutive frames, merges the collected frames using temporal denoising filters, and constructs a single enhanced frame that retains fine-grained spatial detail. The receiving module 206 associates each captured frame with metadata. The metadata includes a timestamp, geographic coordinates, device orientation, environmental illumination data, and the like. The metadata assists the fusion module 218 and the ranking module 220, in context-aware recognition and re-ranking process.

In another embodiment of the present disclosure, the receiving module 206 dynamically adjusts sensor acquisition parameters based on environmental variations. For example, when illumination decreases, the receiving module 206 increases exposure time or sensor gain; when the IMU detects rapid motion, the receiving module 206 shortens exposure to avoid motion blur. The adjustments maintain consistent feature quality and enable reliable downstream processing by the feature extraction module 208. The receiving module 206 outputs pre-processed image data and the associated metadata to the feature extraction module 208 for subsequent feature generation.

In an embodiment of the present disclosure, the receiving module 206 dynamically regulates frame acquisition and pre-processing operations based on the capability of the communication device 104. The receiving module 206 implements adaptive frame-rate control to maintain a stable processing throughput between one and five frames per second, thereby optimizing resource utilization during real-time operation. The receiving module standardizes each captured frame by applying resolution normalization, color-space conversion, and format transformation from device-specific raw output to a standard RGB format. In an example, the resolution may be adjusted to 640×480 pixels for extraction of local features and 224×224 pixels for extraction of global features. The receiving module further employs flow control mechanisms to prevent input buffer overflow under varying capture rates, ensuring consistent data availability for subsequent feature extraction operations.

The feature extraction module 208 operates on the communication device 104 to extract one or more global features and one or more local features from the received image. The global features capture high-level semantic characteristics of the physical environment. The local features encode detailed structural and texture information. The feature extraction module 208 converts the pre-processed image into compact numerical representations optimized for efficient transmission and distributed matching.

In an embodiment of the present disclosure, the feature extraction module 208 includes a hybrid neural processing framework. The hybrid neural processing framework combines a convolutional backbone and a binary descriptor encoder for lightweight on-device feature extraction. The convolutional backbone generates the one or more global features. The one or more global features or global feature embeddings represent overall spatial context. The binary descriptor encoder generates local feature descriptors or the one or more local features optimized for low-latency processing. The hybrid framework ensures a balance between the recognition accuracy and device efficiency by reducing inference latency and transmission bandwidth.

The feature extraction module 208 may perform normalization and scale alignment before feature computation. The normalization adjusts image scale and illumination variations. The alignment compensates for camera-pose distortions. The feature extraction module 208 generates global feature vectors through convolutional feature maps followed by pooling and normalization. In parallel, the local feature branch detects keypoints and produces binary descriptors using algorithms such as ORB or a learned descriptor network. Each descriptor represents localized patterns within the captured environment and remains robust to rotation and illumination changes.

In an embodiment of the present disclosure, the feature extraction module 208 incorporates a confidence-estimation subroutine to evaluate reliability of the extracted features. The subroutine assigns confidence scores to each of the one or more global features and the one or more local features based on contrast, keypoint density, and noise level. The feature extraction module 208 stores the generated one or more global features and the one or more local features in a structured buffer within the non-transitory memory 204a. The stored features serve as input to the uplink module 210 for subsequent transmission to the cloud server 106 and to the descriptor matching module 216 for local correlation.

In a further embodiment of the present disclosure, the feature extraction module 208 adapts a computation strategy based on available device resources. When the communication device 104 detects reduced processing capability or low battery state, the feature extraction module 208 simplifies the convolutional backbone by enabling quantized feature maps. Accordingly, the feature extraction module 208 adapts functionality according to the processing capability and reduces computation without significant degradation of the recognition accuracy.

In an embodiment of the present disclosure, the feature extraction module 208 executes a dual-path feature extraction process. The dual-path feature extraction process includes a global embedding path and a local descriptor path. The global embedding path processes normalized input frames using a lightweight convolutional neural network architecture, such as a MobileNet or EfficientNet backbone. The lightweight CNN architecture generates a 512-dimensional feature embedding vector representing the high-level semantic content of the scene. The local descriptor path converts the input frame into grayscale and applies a keypoint detection and binary descriptor algorithm, such as ORB or AKAZE. Accordingly, the local descriptor path extract between 200 and 500 local feature points. The feature extraction module 208 executes both paths in parallel processing threads, utilizing thread pooling and synchronization barriers to ensure temporal alignment between outputs. The global embeddings are optionally quantized to a reduced precision format prior to transmission.

The one or more processors 202a, using the uplink module 210, transmit the one or more global features generated by the feature extraction module 208 to the cloud server 106. The cloud server 106 includes the reference vector database 106a that stores a plurality of pre-computed feature descriptors corresponding to known images or reference environments. The uplink module 210 packages the one or more global features, frame identifiers, and the metadata into structured transmission packets and sends the package securely to the cloud server 106 over the communication network 108.

The uplink module 210 employs adaptive transmission control to ensure stable communication between the communication device 104 and the cloud server 106. The uplink module 210 is configured to monitor available bandwidth, signal strength, and latency, and dynamically adjusts packet size and transmission rate. When the available network bandwidth decreases, the uplink module 210 compresses the global feature embeddings using quantized encoding to maintain real-time responsiveness. When the communication device 104 reconnects under improved network conditions, the uplink module 210 transmits uncompressed or higher-resolution feature data to enhance the recognition accuracy.

The uplink module 210 supports multiple communication interfaces, such as fifth-generation (5G) cellular networks, Wi-Fi 6, and edge gateway links. The uplink module 210 automatically switches between available interfaces based on network conditions to minimize round-trip latency and prevent data loss. Each transmission packet generated by the uplink module 210 includes authentication tokens, timestamps, and session identifiers. In addition, the transmission packet data maintains traceable and secure communication between the communication device 104 and the cloud server 106

In an embodiment of the present disclosure, the uplink module 210 transmits the auxiliary sensor data, such as depth maps, accelerometer readings, or gyroscope signals, in addition to the one or more global features. The auxiliary sensor data assists the execution module 212 in improving the recognition accuracy by combining visual and non-visual modalities during the similarity computation. The multimodal integration performed at the cloud server 106 enhances robustness in scenarios involving occlusion, lighting variation, or complex object geometry.

In an embodiment of the present disclosure, the uplink module 210 serializes the extracted global features and corresponding metadata into a binary transmission payload. The metadata includes, for example, a timestamp, a device identifier, and frame index information for session continuity. The uplink module 210 optionally applies compression or encoding techniques to reduce network load and enhance data transfer efficiency. The serialized payload is transmitted to the cloud server through a secure HTTP or HTTPS connection using an asynchronous, non-blocking communication protocol. The uplink module 210 includes timeout management to handle delayed responses and ensure uninterrupted operation. The communication architecture maintains low latency and prevents interface interruptions during the continuous feature extraction and recognition workflow.

The one or more processors 202b, using the execution module 212, execute the global similarity search operation at the cloud server 106. The execution module 212 performs the global similarity search operation by initiating comparison of the one or more global features with the plurality of pre-computed feature descriptors. The plurality of pre-computed feature descriptors are stored in the reference vector database 106a. Next, the execution module 212 is configured to perform calculation of one or more global similarity scores. The one or more global similarity scores represent a degree of similarity between the one or more global features and the plurality of pre-computed feature descriptors. Further, the global similarity search operation includes another step of identifying one or more candidate reference images based on the calculated similarity scores. The one or more candidate reference images are ranked according to a corresponding degree of similarity with the one or more global features.

The execution module 212 compares the received global feature embeddings with the stored embeddings and identifies the one or more candidate reference images exhibiting the highest similarity scores. In an embodiment, the execution module 212 performs a selection process for the best matching images based on a level of similarity between the global feature embeddings and the stored embeddings. In an embodiment, the global similarity search uses distance metrics such as cosine similarity, Euclidean distance, or Hamming distance, depending on the embedding type. The execution module 212 retrieves a ranked list of candidate reference images and the corresponding pre-computed descriptors from the reference vector database 106a for further processing.

The execution module 212 implements scalable search techniques to maintain real-time responsiveness under large datasets. In an embodiment of the present disclosure, the execution module 212 employs a near-neighbour indexing algorithm. The near-neighbour indexing algorithm may include locality-sensitive hashing (LSH), product quantization, or hierarchical navigable small-world (HNSW) graphs. The near-neighbour indexing methods reduce search time and improve efficiency by organizing the feature descriptors into high-dimensional data structures optimized for rapid similarity computation.

The execution module 212 stores the candidate reference image identifiers, similarity scores, and ranking metadata temporarily in the non-transitory memory 204b. The execution module 212 generates a recognition response package containing the selected reference candidate images, the pre-computed feature descriptors, and the associated metadata. The metadata may include environmental conditions, confidence values, and the like. The recognition response package is transmitted to the relay module 214 for downstream communication to the communication device 104.

In another embodiment of the present disclosure, the execution module 212 includes a context-aware refinement layer for improving ranking stability under environmental variations. The refinement layer reorders the candidate reference images based on contextual parameters. The contextual parameters may include illumination category, time of day, or geographic coordinates stored in association with the reference vector database 106a. The reordering ensures that the selected candidates correspond to both aspects related to visually similar images and contextually relevant environments.

The execution module 212 supports incremental updates to the reference vector database 106a. Upon receiving the validated recognition results from the ranking module 220 or the fusion module 218, the execution module 212 updates the reference vector database 106a with newly confirmed global embeddings. The update mechanism maintains the relevance and freshness of the stored pre-computed feature descriptors across distributed recognition sessions.

In the server-exclusive processing mode, the execution module 212 performs feature extraction on the images received directly from the communication device 104 without local processing. The execution module 212 extracts both the global features and the local features, executes the global similarity search, and generates the final recognition outputs. The final recognition results are transmitted back to the communication device 104 for display using the display module 222. The server-exclusive processing mode reduces device-side computational load and enables lightweight operation on resource-constrained devices.

In another embodiment, the cloud server 106 implements a distributed similarity search architecture across multiple cloud nodes to enhance scalability and throughput. Each cloud node maintains a partition of the reference vector database 106a and executes parallelized near-neighbour search operations. The aggregated similarity results from the distributed nodes are combined and ranked to produce the final candidate reference image set. The multi-node design enables efficient large-scale recognition across millions of stored image descriptors.

In an embodiment of the present disclosure, the execution module 212 validates each received global embedding payload for dimensional consistency and data integrity prior to processing. The execution module 212 performs the global similarity search operation by comparing the received embeddings with the plurality of pre-computed feature descriptors stored within the reference vector database. The search employs approximate nearest neighbor (ANN) indexing techniques, such as hierarchical navigable small-world (HNSW) graphs, locality-sensitive hashing (LSH), or product quantization (PQ), to achieve efficient retrieval from large-scale datasets. The execution module 212 retrieves the defined number of top candidate reference images, for example, between ten and fifty, exhibiting the highest degree of similarity to the received global embeddings. The corresponding pre-computed local descriptors and metadata of the candidate reference images are prepared for transmission to the communication device 104 through the relay module 214.

The one or more processors 202b, using the relay module 214, transmit one or more sets of pre-computed descriptors corresponding to the one or more candidate reference images. The relay module 214 formats and packages the recognized candidate data into a structured recognition response packet for low-latency transmission. The data package includes the pre-computed feature descriptors, the similarity scores, and the contextual metadata,

The relay module 214 employs an adaptive compression mechanism to optimize data size according to network conditions and device bandwidth. When the available bandwidth decreases, the relay module 214 prioritizes transmission of high-confidence candidate descriptors and progressively transmits the remaining data in the background. The prioritization mechanism ensures that the communication device 104 receives sufficient data to perform immediate local matching without waiting for the complete dataset.

The relay module 214 supports a priority-based encoding scheme in which top-ranked candidate descriptors are transmitted first, followed by lower-ranked candidates. Also, the relay module 214 embeds synchronization parameters generated by the descriptor matching module 216 to maintain correct sequencing and coherence of data received at the communication device 104. In multi-user deployments, the relay module 214 assigns distinct transmission lanes based on session identifiers to ensure consistent recognition response quality across parallel sessions.

In an embodiment of the present disclosure, the cloud server 106 transmits identifiers and associated metadata of the one or more sets of the pre-computed descriptors. The metadata may include information such as object category, contextual tags, and relevance confidence values. The inclusion of the identifiers and the descriptors enables the communication device 104 to perform precise local re-ranking and contextual visualization, and maintaining lightweight communication overhead.

The one or more processors 202a, using the descriptor matching module 216, perform local descriptor matching. The local descriptor matching is performed between the one or more local features extracted by the feature extraction module 208 and the one or more sets of pre-computed descriptors received from the cloud server 106. The descriptor matching module 216 executes local correlation to refine recognition accuracy by computing localized similarity between the captured image and the candidate reference images transmitted by the cloud server 106.

The descriptor matching module 216 organizes the local features into a hierarchical descriptor tree structure. The descriptor matching module 216 performs Hamming distance computation between the local descriptors and the pre-computed candidate descriptors to generate refined similarity scores. The hierarchical matching approach significantly reduces computational overhead by limiting direct descriptor comparisons to relevant regions of interest.

In an embodiment of the present disclosure, the descriptor matching module 216 applies region-of-interest (ROI) segmentation before the descriptor comparison process. The segmentation identifies texture-rich or edge-dense areas in the captured image and restricts matching operations for the identified regions. The segmentation improves both accuracy and efficiency. The descriptor matching module 216 may discard low-confidence matches by applying a similarity threshold filter to eliminate spurious descriptor correlations.

The descriptor matching module 216 aggregates the validated descriptor pairs into a cumulative local similarity map. The local similarity map represents correlation confidence across spatial regions of the image. The local similarity scores are transmitted to the fusion module 218 for combination with the one or more global similarity scores generated by the execution module 212. The descriptor matching module 216 acts as an intermediary between global search results and final recognition fusion.

The one or more processors 202a, using the fusion module 218, fuse the refined local similarity scores with the one or more global similarity scores to determine an initial recognition result. The fusion module 218 applies a weighted normalization function to combine the one or more global similarity scores and the local similarity scores. The weights are dynamically computed based on a confidence value derived from the number of candidate reference images and the consistency of the matched descriptor regions.

In an embodiment of the present disclosure, the fusion module 218 employs a confidence reweighting routine that adjusts the relative contribution of the global and local similarity components. The routine ensures stable recognition outcomes under variable conditions such as lighting variation, partial occlusion, or feature loss. The fusion module 218 normalizes the fused scores to produce a unified similarity metric. The unified similarity metric represents the most probable recognition outcome corresponding to the physical environment captured by the communication device 104.

In another embodiment, the fusion module 218 associates each recognition result with an uncertainty metric indicating the reliability of the fused similarity value. The uncertainty metric is computed from descriptor variance, feature entropy, and candidate dispersion. The metrics are used by the ranking module 220 for progressive re-ranking of the recognition results during continuous refinement.

In an embodiment of the present disclosure, the ranking module 220 performs progressive refinement of the recognition results. The progressive refinement is performed through continuous interaction between the communication device 104 and the cloud server 106. The ranking module 220 decodes the serialized descriptors received from the cloud server 106 and reconstructs the local descriptor matrices for each candidate reference image. As new local features are extracted and transmitted from the communication device 104, the ranking module 220 iteratively reorders the candidate reference images. The iterative reordering is based on updated similarity measures and temporal consistency. The iterative re-ranking enables continuous improvement in recognition accuracy over time and ensures stable performance across variable viewing angles and illumination conditions during ongoing recognition sessions.

The system 100 operates in an edge–cloud cooperative mode. The computational workflow is dynamically distributed between the communication device 104, an optional edge node, and the cloud server 106 to optimize latency, bandwidth usage, and energy efficiency. The global similarity search and the large-scale descriptor indexing operations are primarily executed at the cloud server 106. The local descriptor matching, fusion, and re-ranking functions are executed at the communication device 104. The cooperative division ensures that computationally intensive tasks are performed on high-performance cloud infrastructure. The latency-sensitive tasks are handled locally for real-time responsiveness.

In an embodiment of the present disclosure, the system 100 dynamically adjusts the distribution of computational load between the communication device 104 and the cloud server 106. The system 100 adjusts the distribution of the computational load based on factors such as device processing capability, current network conditions, and power availability. The one or more processors 202a and 202b collectively monitor performance indicators. The performance indicators include frame rate, bandwidth usage, and energy consumption to determine the optimal partition of operations. When the communication device 104 detects degraded connectivity or reduced processor capacity, the system 100 shifts partial descriptor matching or fusion operations to the cloud server 106 to maintain continuity of recognition performance.

Conversely, when network latency increases or the cloud workload becomes saturated, the system 100 temporarily offloads additional computation to the communication device 104. The additional computation includes local re-ranking or feature refinement. The bidirectional load balancing enables seamless operation under varying conditions without perceptible delays or performance degradation. The descriptor matching module 216 maintains alignment of distributed processing tasks and ensures consistent recognition state across client and server environments.

The system 100 employs the scalable reference vector database 106a on the cloud server 106 for executing the global similarity search. The reference vector database 106a stores the plurality of pre-computed feature descriptors derived from reference images, annotated scenes, or known object categories. The database supports the near-neighbour indexing techniques, such as locality-sensitive hashing (LSH), product quantization, or hierarchical navigable small-world (HNSW) graphs. The indexing techniques allow the system 100 to perform high-dimensional similarity searches in sub-linear time and maintain robust accuracy across large datasets.

In an embodiment, the cloud server 106 performs context-aware refinement of the global similarity search results by fusing the auxiliary sensor data received from the communication device 104. The auxiliary sensor data may include depth maps, accelerometer readings, or gyroscope signals. The fused multimodal data improves recognition reliability under conditions involving motion blur, partial occlusion, or variable lighting. The execution module 212 integrates the multimodal cues into the similarity computation pipeline. Accordingly, the execution module 212 generates more contextually consistent recognition outputs.

The system 100 supports a server-exclusive processing mode that enables lightweight operation of the communication device 104. In the server-exclusive mode, the communication device 104 transmits the captured image directly to the cloud server 106, bypassing local feature extraction and matching stages. The cloud server 106, using the execution module 212, performs the feature extraction, similarity search, and re-ranking operations entirely on the server side. The final recognition outputs are transmitted to the display module 222 on the communication device 104 for visualization. The server exclusive mode is particularly beneficial for resource-constrained devices or scenarios involving high-latency environments where continuous uplink transmission of feature data is more efficient than distributed processing.

The system 100 automatically transitions between the distributed and server-exclusive processing modes based on operational conditions. The transition decision is managed by a load-balancing controller implemented within the descriptor matching module 216. The controller continuously evaluates network latency, device utilization, and energy level thresholds. The intelligent distribution mechanism ensures optimal utilization of available computational resources and maintains consistent user experience during real-time recognition and contextual rendering operations.

In another embodiment, the edge–cloud cooperative architecture supports integration with edge servers deployed geographically closer to the communication device 104. When an edge node is available, the execution module 212 may offload initial global similarity computation to the edge server, and the ranking module 220 executes re-ranking locally. The edge-cloud architecture reduces end-to-end response latency and enables near-instantaneous recognition even under limited cloud connectivity. The descriptor matching module 216 manages communication between the edge node and the cloud server 106 to maintain unified model consistency and recognition state across distributed layers.

Accordingly, the distributed architecture defined by the communication device 104, the cloud server 106, and the optional edge node collectively enables robust, scalable, and adaptive recognition workflows. The architecture balances precision, latency, and energy consumption to deliver a seamless recognition experience across heterogeneous device configurations and network environments. The hybrid recognition pipeline operates in a progressive manner with continuous interaction between the communication device 104 and the cloud server 106. The communication device 106 transmits the one or more global features extracted from sequential camera frames to the cloud server 106 for the near-neighbour matching. The cloud server 106 returns the one or more candidate reference descriptors and refines the recognition results as new local features are received. The refinement of the recognition results enables real-time re-ranking and improved recognition accuracy during continuous user interaction.

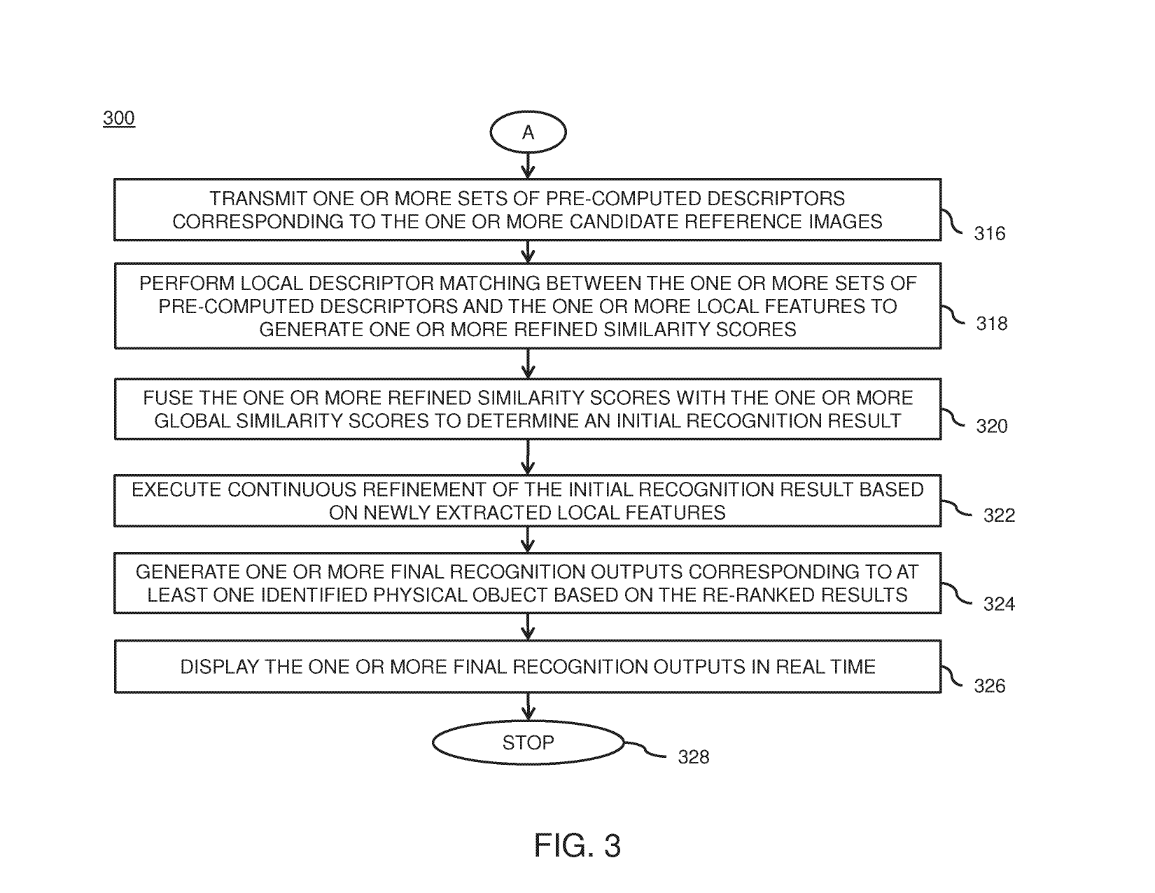

FIG. 3 illustrates a flowchart 300 depicting a method for performing the distributed recognition and visualization of the recognition outputs using the hybrid recognition pipeline, in accordance with various embodiments of the present disclosure. The method is implemented by the one or more processors 202a and 202b of the communication device 104 and the cloud server 106 respectively. The one or more processors 202a and 202b are configured with program instructions stored in the corresponding non-transitory memory 204a and 204b respectively. The method describes a collaborative workflow between the communication device 104 and the cloud server 106. The communication device 104 and the cloud server 106 perform specific stages of the distributed image recognition process.

The flowchart initiates at step 302. At step 304, the method includes a step of receiving, using the one or more processors 202a at the communication device 104, the at least one image of the physical environment. The at least one image is captured by the one or more sensors 104A embedded in the communication device 104. The received image may include visual, spatial, or orientation data corresponding to the physical environment of the user 102.

At step 306, the method includes another step of extracting, at the communication device 104, the one or more global features and the one or more local features from the received image. The one or more processors 202a, using the feature extraction module 208, extract the one or more global features and the one or more local features from the received image. The one or more global features represent high-level semantic information of the captured scene, and the one or more local features represent fine-grained geometric details. The feature extraction module 208 utilizes the hybrid neural processing framework to perform lightweight on-device feature generation.

At step 308, the method includes yet another step of transmitting, from the communication device 104, the one or more global features to the cloud server 106. The one or more processors 202a, using the uplink module 210 at the communication device 104, transmit the one or more global features to the cloud server 106. The cloud server 106 is configured with the reference vector database 106a. The reference vector database 106a stores the plurality of pre-computed feature descriptors associated with the reference images. The uplink module 210 attaches the metadata and the session identifiers through the transmission packet for synchronization during distributed processing.

At step 310, the method includes yet another step of executing the global similarity search operation. The one or more processors 202a, using the execution module 212 at the cloud server 106, executes the global similarity search on the plurality of pre-computed feature descriptors stored in the reference vector database 106a. The global similarity search operation includes the step of comparing the one or more global features with the plurality of pre-computed feature descriptors. The plurality of pre-computed feature descriptors are stored in the reference vector database 106a.

At step 312, the method includes a subsequent step for executing the global similarity search operation at the cloud server 106. In addition, the search operation includes the subsequent step of calculating the one or more global similarity scores. The one or more global similarity scores represent the degree of similarity between the one or more global features and the plurality of pre-computed feature descriptors.

At step 314, the method includes a final step for completion of the global similarity search operation at the cloud server 106. In addition, the search operation includes the final step of identifying the one or more candidate reference images based on the calculated similarity scores. The one or more candidate reference images are ranked according to the corresponding degree of similarity with the one or more global features. The execution module 212 identifies the one or more candidate reference images exhibiting the highest similarity scores relative to the received one or more global features.

At step 316, the method includes yet another step of transmitting the one or more sets of pre-computed descriptors corresponding to the one or more candidate reference images to the communication device 104. The one or more processors 202b, using the relay module 214 at the cloud server 106, transmit the one or more sets of pre-computed descriptors corresponding to the one or more candidate reference images to the communication device 104. The relay module 214 applies the adaptive compression and the structured data packaging to optimize bandwidth utilization during transmission.

At step 318, the method includes yet another step of performing the local descriptor matching, at the communication device 104, between the one or more local features and the one or more candidate reference image descriptors to generate the one or more refined similarity scores. The one or more processors 202a, using the descriptor matching module 216 at the communication device 104, perform the local descriptor matching between the one or more candidate reference images and the one or more local features. The descriptor matching module 216 computes the one or more refined similarity scores using thehierarchical matching and distance-based comparison techniques.

At step 320, the method includes yet another step of fusing the one or more refined similarity scores with the one or more global similarity scores to determine the initial recognition result. The one or more processors 202a, using the fusion module 218 at the communication device 104, fuse the one or more refined similarity scores with the one or more global similarity scores received from the cloud server 106 to determine an initial recognition result. The fusion module 218 applies a weighted normalization function to combine both sets of similarity scores, wherein the weights are dynamically computed based on a confidence value derived from a number of candidate images and consistency of matched regions.

At step 322, the method includes yet another step of executing the iterative re-ranking process distributed between the communication device 104 and the cloud server 106 to continuously refine the recognition results. The results are refined based on the additional local features extracted from the subsequent camera frames, and transmitted from the communication device 104 to the cloud server 106. The one or more processors 202a, using the ranking module 220 distributed between the communication device 104 and the cloud server 106, execute the continuous refinement of the recognition results. The ranking module 220 performs the iterative re-ranking of the candidate reference images in real time.

In an embodiment of the present disclosure, the preliminary recognition results are displayed on the communication device 104 as the re-ranking and the refinement processes continue in the background. The communication device 104 updates the displayed recognition outputs asynchronously as new local features are extracted and transmitted to the cloud server 106. The progressive updating mechanism allows the user 102 to receive early recognition feedback and simultaneously benefit from improved accuracy as the iterative recognition process converges.

At step 324, the method includes yet another step of generating, at the cloud server 106, the final recognition outputs corresponding to the identified physical objects based on the re-ranked results. The one or more processors 202a generate the one or more final recognition outputs corresponding to the at least one identified physical object based on the re-ranked results. The final recognition outputs represent the recognized objects, surfaces, or scenes derived from the distributed recognition pipeline.

At step 326, the method includes yet another step of displaying the recognition outputs in real time at the communication device 104. The one or more processors 202a, using the display module 222 at the communication device 104, display the one or more of the recognition outputs in real time. The recognition outputs are visualized on the display interface of the communication device 104, providing the user 102 with accurate, real-time recognition feedback based on the hybrid processing results.

In an embodiment of the present disclosure, the method further includes dynamically adjusting the distribution of the computational load between the communication device 104 and the cloud server 106 based on network latency, device capability, or power availability. The adaptive load distribution ensures balanced performance and optimized resource utilization during real-time recognition.

In another embodiment of the present disclosure, the method supports an alternate processing mode in which the communication device 104 transmits the captured image directly to the cloud server 106. The cloud server 106 performs the feature extraction, the similarity search, and the re-ranking to generate the final recognition outputs without local computation.

In practical implementation, the disclosed system can be utilized by software developers and service providers across a wide spectrum of industries. Cloud service providers may integrate the hybrid recognition pipeline into existing infrastructure to deliver optimized computer vision services at scale. E-commerce platforms can employ the system for visual search and product identification, while industrial and logistics operators can use it for inventory tracking and defect detection. Gaming studios and interactive media platforms can adopt the system to provide fast, recognition-driven gameplay experiences with real-time object awareness.

Furthermore, the disclosed system is adaptable to education, healthcare, and digital documentation domains where accurate recognition and visualization of real-world objects are required. The hybrid recognition pipeline ensures high performance on both consumer-grade mobile devices and enterprise-scale cloud systems by dynamically distributing the computational load based on network and hardware conditions. The modular design allows seamless integration with existing visual processing frameworks and supports large-scale deployments across distributed devices. Accordingly, the present disclosure provides a versatile and scalable technological foundation for next-generation recognition-driven visualization systems and intelligent computing applications requiring real-time, data-efficient, and context-aware recognition performance.

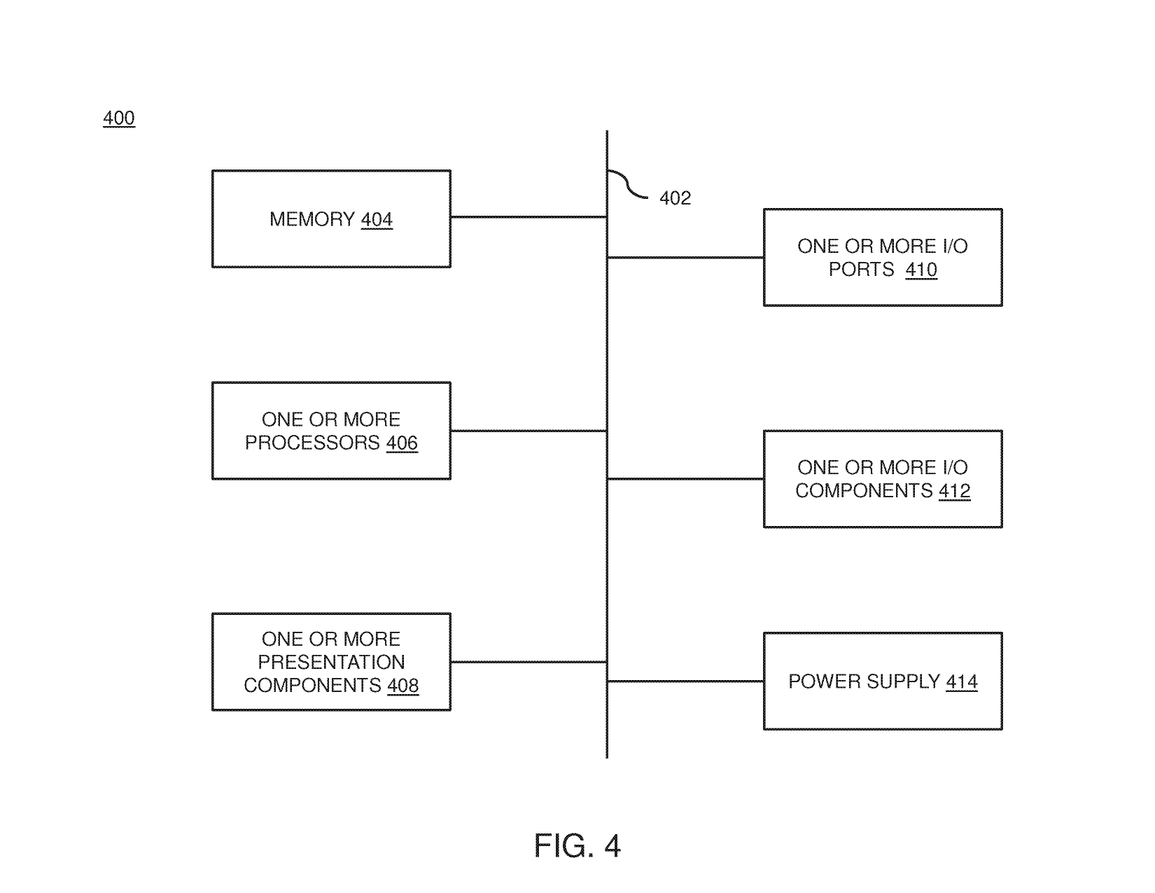

FIG. 4 illustrates a block diagram of an exemplary device 400 configured for executing the distributed image recognition and the visualization of the recognition outputs, in accordance with various embodiments of the present disclosure. The device 400 is representative of the communication device 104, or any computing entity configured to operate the system 100, the modular processing pipeline, and the hybrid recognition framework. The device 400 may be implemented as a non-transitory computer-readable storage medium storing instructions for executing image capture, feature extraction, similarity matching, ranking, and visualization processes in real time.

The device 400 includes a bus 402 that directly or indirectly couples a memory 404, one or more processors 406, one or more presentation components 408, one or more input/output (I/O) ports 410, one or more I/O components 412, and a power supply 414. The bus 402 represents one or more communication channels, such as an address bus, a data bus, or a combination thereof, for enabling communication among the device components and supporting high-speed data transfer during the real-time distributed recognition process.

In practice, the delineation between various components may not be strict, and several elements may overlap in function. For example, a presentation component such as a display may also be considered an I/O component, and the one or more processor 406 may integrate cache or embedded memory. The illustration in FIG. 4 is therefore exemplary and non-limiting, serving as a logical representation of hardware elements that collectively enable the distributed recognition and visualization of recognition results.

The device 400 includes one or more types of computer-readable media accessible to the one or more processor 406. The computer-readable media may include volatile or non-volatile, removable or non-removable memory elements that store data, feature descriptors, metadata, and executable program instructions used during distributed recognition and ranking. The computer storage media may include random-access memory (RAM), read-only memory (ROM), electrically erasable programmable read-only memory (EEPROM), flash memory, hard drives, solid-state drives, optical or magnetic discs, or any medium capable of storing data and program instructions. The communication media may embody data or instructions in a modulated data signal, such as a carrier wave, transmitted through wired or wireless communication channels including Wi-Fi, 5G, Bluetooth, infrared, or satellite-based links.

The memory 404 stores computer-readable instructions that, when executed by the one or more processors 406, cause the device 400 to perform operations such as receiving captured image data from one or more sensors 104A, extracting one or more global features and one or more local features, transmitting global features to a cloud server 106, performing local descriptor matching, computing refined similarity scores, and displaying recognition results. The memory 404 may include structured data buffers for storing image frames, feature vectors, embedding tensors, similarity matrices, and ranking metadata.

The one or more processors 406 execute the instructions stored in the memory 404 to perform computational operations required for distributed recognition. The one or more processors 406 may include central processing units (CPUs) for control operations, graphics processing units (GPUs) for feature extraction and parallel similarity computation, digital signal processors (DSPs) for image and signal preprocessing, and artificial intelligence accelerators such as neural processing units (NPUs) or tensor cores for executing feature encoding and ranking model inference. In some embodiments, the one or more processors 406 cooperate to achieve parallelized feature extraction and descriptor matching to ensure low-latency response during real-time recognition sessions.

The one or more presentation components 408 generate perceptible output to the user 102. Exemplary components include a display screen or a head-mounted display that visualizes recognized objects, interactive overlays, or contextual information derived from the recognition results. The one or more presentation components 408 may further include speakers or haptic feedback modules that provide auditory or tactile cues corresponding to identified objects or locations. The one or more presentation components 408 collectively enable visualization of recognition outputs in real time with spatial and contextual coherence.

The one or more I/O ports 410 facilitate communication between the device 400 and external systems, networks, or peripheral sensors. Examples include USB-C, HDMI, or Thunderbolt interfaces used for connecting external cameras, computing modules, or diagnostic tools. The one or more I/O components 412 serve as input mechanisms for capturing environmental or user-related data. Illustrative components include the camera module, depth sensor, LiDAR unit, ambient light sensor, microphone, or motion sensor. These components collectively provide input data for the distributed image recognition and feature extraction processes.

The power supply 414 provides energy for device operation. The power supply 414 may include a rechargeable lithium-based battery for portable devices such as smartphones, tablets, or wearable displays, or a wired AC/DC power unit for high-performance computing systems such as workstations or edge servers. In some embodiments, the power supply 414 is optimized for energy-efficient recognition by employing adaptive power scaling during idle or low-load periods.

In operation, the one or more processors 406, the memory 404, and the I/O components 412 operate in a continuous feedback loop to capture sensor data, compute feature embeddings, perform distributed matching, and display recognition results. The captured images and derived features are transmitted between the communication device 104 and the cloud server 106 through the communication network 108, allowing cooperative computation for enhanced accuracy and scalability.

In an embodiment of the present disclosure, the device 400 communicates with a remote cloud server 106 or an edge node to offload computationally intensive operations such as similarity search, candidate re-ranking, or embedding update. The distributed processing ensures balanced workload distribution, bandwidth optimization, and consistent recognition performance across multiple devices operating under the same system framework.

The arrangement of components shown in FIG. 4 is illustrative and not restrictive. Fewer or additional components may be included depending on implementation requirements. Functions described as being performed by one component may alternatively be distributed across multiple components or modules. The device 400 is therefore representative of a flexible and scalable computing architecture capable of executing distributed image recognition and visualization processes across heterogeneous platforms and network configurations.

The method and system of the present invention offer several significant advantages that enhance the overall experience and performance for recognition of images in multiple applications. Firstly, the faster and more accurate image recognition improves the user experience, which results in increased user engagement and satisfaction. Additionally, the system opens up new possibilities across various industries, including e-commerce, navigation, and entertainment. By enabling more precise real-time image recognition, the system enhances virtual try-ons, improves navigation guidance, and enables immersive gaming and interactive experiences. Lastly, the system provides a competitive advantage for developers, allowing them to create AR applications with superior performance and accuracy. This gives developers an edge in a highly competitive market, where fast, reliable, and engaging AR solutions are essential for attracting and retaining users. Overall, the invention’s advanced image recognition capabilities not only elevate the AR experience but also expand the potential applications and improve the competitiveness of developers in the field.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for performing distributed recognition on a hybrid recognition pipeline, the system comprising:
at least one communication device comprising one or more processors and a non-transitory memory storing a first set of instructions; and
a cloud server communicatively linked to the at least one communication device and comprising one or more processors and a non-transitory memory storing a second set of instructions,
wherein the one or more processors of the at least one communication device and the one or more processors of the cloud server, upon execution of the corresponding first set of instructions and the second set of instructions, are collectively configured to cause the system to:
receive, at a communication device using a receiving module, at least one image of a physical environment captured by one or more sensors embedded in the communication device;
extract, at the communication device using a feature extraction module, one or more global features and one or more local features from the received image;
transmit, using an uplink module at the communication device, the one or more global features to the cloud server configured with a reference vector database storing a plurality of pre-computed feature descriptors;
execute, at the cloud server using an execution module, a global similarity search operation comprising comparing the one or more global features with a plurality of pre-computed feature descriptors stored in the reference vector database, calculate one or more global similarity scores representing a degree of similarity between the one or more global features and the plurality of pre-computed feature descriptors, and identifying, based on the calculated global similarity scores, one or more candidate reference images ranked according to a corresponding degree of similarity with the one or more global features;
transmit, to the communication device using a relay module at the cloud server, one or more sets of pre-computed descriptors of the one or more candidate reference images and the one or more global similarity scores corresponding to the one or more sets of pre-computed descriptors of the one or more candidate reference images;
perform local descriptor matching, at the communication device using a descriptor matching module, between the one or more sets of pre-computed descriptors associated with the one or more candidate reference images and the one or more local features to generate one or more refined similarity scores;
fuse, at the communication device using a fusion module, the one or more refined similarity scores with the one or more global similarity scores to determine an initial recognition result;
execute, using a ranking module distributed between the communication device and the cloud server, continuous refinement of the initial recognition result based on newly extracted local features transmitted from the communication device to the cloud server;
generate, using the execution module at the cloud server, one or more final recognition outputs corresponding to at least one identified physical object based on the re-ranked results received from the cloud server; and
display, using a display module operatively coupled to the communication device, the one or more final recognition outputs in real time.

2. The system of claim 1, wherein the feature extraction module comprises a hybrid neural processing framework combining a convolutional backbone for generating the one or more global features and the one or more local features for lightweight on-device feature extraction.

3. The system of in claim 1, wherein the descriptor matching module executes local matching using a hierarchical descriptor tree structure and performs Hamming distance computation between the one or more local features and the one or more candidate reference image descriptors to generate the one or more refined similarity scores.

4. The system of in claim 1, wherein the fusion module applies a weighted normalization function for fusing the one or more global similarity scores and the one or more refined similarity scores, wherein the fusion module dynamically computes weights based on a confidence value derived from a number of the candidate reference images and a consistency of matched descriptor regions.

5. The system of claim 1, wherein the system operates in an edge–cloud cooperative mode, wherein the edge-cloud cooperative mode comprises executing the global similarity search at the cloud server, and executing the local descriptor matching, the fusion, and the re-ranking operations at the communication device to balance latency, bandwidth, and computational efficiency.

6. The system of claim 1, wherein the ranking module performs progressive refinement of the recognition results by continuously receiving newly extracted local features from the communication device and reordering candidate reference images at the cloud server in real time.

7. The system of claim 1, wherein the system dynamically adjusts distribution of computational load between the communication device and the cloud server based on processing capability, network conditions, or energy constraints of the communication device.

8. The system of claim 1, wherein the cloud server executes the global similarity search using a near-neighbour indexing technique, wherein the near-neighbour indexing technique comprises one of locality-sensitive hashing, product quantization, or hierarchical navigable small-world graphs.

9. The system of claim 1, wherein the communication device transmits sensor data to the cloud server for enhanced recognition accuracy, wherein the sensor data comprises at least one of a depth map, an accelerometer reading, or a gyroscope signal, and wherein the cloud server fuses the sensor data with the visual features for improving recognition accuracy under variable lighting or occlusion conditions.

10. The system of claim 1, wherein the system supports a server-exclusive processing mode in which the communication device transmits the at least one image directly to the cloud server, and the cloud server performs the feature extraction, the similarity search, and the re-ranking to generate the final recognition outputs without local processing on the communication device.

11. A computer-implemented method for performing distributed image recognition on a hybrid recognition pipeline, the computer-implemented method comprising:
receiving, at a communication device, at least one image of a physical environment captured by one or more sensors integrated within the communication device;
extracting, at the communication device, one or more global features and one or more local features from the received image;
transmitting, at the communication device, the one or more global features to a cloud server configured with a reference vector database storing a plurality of pre-computed feature descriptors;
executing, at the cloud server, a global similarity search operation comprising comparing the one or more global features with a plurality of pre-computed feature descriptors stored in the reference vector database, calculate one or more global similarity scores representing a degree of similarity between the one or more global features and the plurality of pre-computed feature descriptors, and identifying, based on the calculated one or more global similarity scores, one or more candidate reference images ranked according to a corresponding degree of similarity with the one or more global features;
transmitting, to the communication device by the cloud server, one or more sets of pre-computed descriptors corresponding to the one or more candidate reference images and the one or more global similarity scores corresponding to the one or more sets of pre-computed descriptors of the one or more candidate reference images;
performing local descriptor matching, at the communication device, between the one or more sets of pre-computed descriptors associated with the one or more candidate reference images and the one or more local features to generate one or more refined similarity scores;
fusing, at the communication device, the one or more refined similarity scores with the one or more global similarity scores to determine an initial recognition result;
executing continuous refinement of the initial recognition result based on newly extracted local features transmitted from the communication device to the cloud server;
generate, using the one or more processors of the communication device, one or more final recognition outputs corresponding to at least one identified physical object based on the re-ranked results received from the cloud server; and
display, using a display module operatively coupled to the communication device, the one or more final recognition outputs in real time.

12. The computer-implemented method of claim 11, wherein the hybrid neural processing framework combines a convolutional backbone for generating the one or more global features and the one or more local features for lightweight on-device feature extraction.

13. The method of claim 11, wherein the local matching is executed using a hierarchical descriptor tree structure and Hamming distance computation between the one or more local features and the one or more candidate reference image descriptors to generate the one or more refined similarity scores.

14. The computer-implemented method of claim 11, wherein the one or more global similarity scores are fused with the one or more refined similarity scores by using a weighted normalization function, wherein the fusion dynamically computes weights based on a confidence value derived from a number of the candidate reference images and a consistency of matched descriptor regions.

15. The computer-implemented method of claim 11, wherein the computer-implemented method comprises operation in an edge–cloud cooperative mode, wherein the edge-cloud cooperative mode comprises executing the global similarity search at the cloud server, and executing the local descriptor matching, the fusion, and the re-ranking operations at the communication device to balance latency, bandwidth, and computational efficiency.

16. The computer-implemented method of claim 11, wherein the progressive refinement of the recognition results continuously receives newly extracted local features from the communication device and reordering candidate reference images at the cloud server in real time.

17. The computer-implemented method of claim 11, wherein the computer-implemented method comprises dynamically adjusting distribution of computational load between the communication device and the cloud server based on processing capability, network conditions, or energy constraints of the communication device.

18. The computer-implemented method of claim 11, wherein the global similarity search is executed using a near-neighbour indexing technique, wherein the near-neighbour indexing technique comprises one of locality-sensitive hashing, product quantization, or hierarchical navigable small-world graphs.

19. The method of claim 11, further comprising transmitting sensor data for enhanced recognition accuracy, wherein the sensor data comprises at least one of a depth map, an accelerometer reading, or a gyroscope signal, and wherein the cloud server fuses the sensor data with visual features for improving recognition accuracy under variable lighting or occlusion conditions.

20. A non-transitory computer-readable storage medium storing computer-executable instructions that, when executed by one or more processors of a computing device, cause the computing device to perform a method for performing distributed image recognition on a hybrid recognition pipeline, the method comprising:
receiving, at a communication device, at least one image of a physical environment captured by one or more sensors integrated within the communication device;
extracting, at the communication device, one or more global features and one or more local features from the received image;
transmitting, at the communication device, the one or more global features to a cloud server configured with a reference vector database storing a plurality of pre-computed feature descriptors;
executing, at the cloud server, a global similarity search operation comprising comparing the one or more global features with a plurality of pre-computed feature descriptors stored in the reference vector database, calculate one or more global similarity scores representing a degree of similarity between the one or more global features and the plurality of pre-computed feature descriptors, and identifying, based on the calculated one or more global similarity scores, one or more candidate reference images ranked according to a corresponding degree of similarity with the one or more global features;
transmitting, to the communication device by the cloud server, one or more sets of pre-computed descriptors corresponding to the one or more candidate reference images and the one or more global similarity scores corresponding to the one or more sets of pre-computed descriptors of the one or more candidate reference images;
performing local descriptor matching, at the communication device, between the one or more sets of pre-computed descriptors associated with the one or more candidate reference images and the one or more local features to generate one or more refined similarity scores;
fusing, at the communication device, the one or more refined similarity scores with the one or more global similarity scores to determine an initial recognition result;
executing continuous refinement of the initial recognition result based on newly extracted local features transmitted from the communication device to the cloud server;
generate, using the one or more processors of the communication device, one or more final recognition outputs corresponding to at least one identified physical object based on the re-ranked results received from the cloud server; and
display, using a display module operatively coupled to the communication device, the one or more final recognition outputs in real time.
